(19) United States
(12) Patent Application Publication
(10) Pub. No.: US 2023/0014748 A1
(43) Pub. Date: Jan. 19, 2023

(54) METHOD FOR PRODUCING A FIBRE COMPOSITE BODY AND FIBRE COMPOSITE BODY

(71) Applicant: ACTION COMPOSITES HIGHTECH GMBH, Kesselsdorf (DE)

(72) Inventors: Jens WERNER, Coswig (DE); Sandro MÄKE, Dohma (DE); Michael FRANKE, Dresden (DE); Christian KÖHLER, Dresden (DE); Florian FRANKE, Dresden (DE); Michael DRESSLER, Dresden (DE); André BARTSCH, Dresden (DE)

(73) Assignee: ACTION COMPOSITES HIGHTECH GMBH, Kesselsdorf (DE)

(21) Appl. No.: 17/757,686

(22) PCT Filed: Nov. 25, 2020
(86) PCT No.: PCT/EP2020/083359

§ 371 Date: Jun. 17, 2022

(30) Foreign Application Priority Data
Dec. 18, 2019 (DE) 10 2019 135 001.8

(51) Int. Cl. B60B 5/02; B60B 3/10; B29C 70/48

(52) U.S. Cl. CPC B60B 5/02; B60B 3/10; B29C 70/48; B60B 2310/204; B60B 2360/32; B60B 2360/341; B60B 2900/111; B29L 2031/32

(57) ABSTRACT

The invention relates to a method for producing a fibre composite body (2), in particular at least a part of a wheel, comprising the following steps: providing a mould (4) having at least one female mould part (6) and one male mould part, introducing a fibrous raw material (8) and a binder (10) into the female mould part (6), activating the binder (10) by an energy input (p, T) into the mould (4) to form a mould element (12) which is open to diffusion, joining together the mould element (12) which is open to diffusion and a preform structure (14), supplying a resin, so that the resin infiltrates at least partially into the mould element (12) which is open to diffusion and into the preform structure (14), and curing the resin, so that in this way the fibre composite body (2) is formed without a boundary layer.

### DESCRIPTION

The invention relates to a method for producing a fibre composite body and to a fibre composite body.

Fibre composite materials are widely used today and are becoming increasingly important due to their mechanical properties. Fibre composite materials and components made from materials of this type are of interest, for example, for the aviation and/or automotive industry, especially because of their low weight and high mechanical strength.

So-called insert parts are usually required for fibre composite bodies, i.e. parts made of a fibre composite material. These insert parts serve to mechanically stabilise regions of a fibre composite body in which there are, for example, changes in wall thickness and/or changes in geometry. However, regions that are exposed to particular mechanical stress, such as screw connection regions or attachment points, are also typical examples of applications where insert parts are used. These insert parts then serve as an additional mechanical reinforcement of this region.

Especially in the case of wheels, i.e. wheel rims made of a fibre composite material, for example carbon, regions of this type are, for example, the hub region (connection to the vehicle) and the rim base.

EP 2788200 B1 shows an insert part made of a plastics material which is produced by means of deep drawing, injection moulding or thermoforming. In order to make a boundary layer between the insert part and a preform structure surrounding it resistant, surface activation is usually necessary, which makes this configuration complex and expensive.

WO 2019033173 A1 describes a preformed insert part made of a fibre composite material which is cured and has special mechanical properties for infiltration with a preform structure of a wheel after curing. In this case, the insert part has at least one layer of unidirectional fibres, a layer of multiaxial fibre fabric, and a layer of non-woven material. Optionally, fillers such as glass, hollow spheres, silicic acid, epoxy/curing agents and comminuted and/or ground carbon fibres or a combination thereof can also be added in this case.

The resulting boundary layer between the insert part and the preform structure can be understood as a material notch and thus as a weakening. As a result of this weakening, detachment can occur between the insert part and the preform structure. The surfaces therefore have to be subjected to complex cleaning processes, such as surface activation. Furthermore, it is desirable to be able to compensate for tolerances that have arisen between the insert part, the preform structure, and the infiltration mould. This is important to achieve a homogeneous and high fibre volume content in the end component. Proceeding from this, the invention is based on the object of specifying a method for producing a fibre composite body which requires little effort and is inexpensive. Furthermore, the invention is based on the object of specifying a partially resilient fibre composite body which, as a result of its resilient compressibility, can compensate for tolerances, but can also blend in to a large extent with adjacent structures (preform, other insert parts).

With regard to the method, the object is achieved according to the invention by a method for producing a fibre composite body having the features of claim 1. With regard to the fibre composite body, the object is achieved according to the invention by a fibre composite body having the features of claim 11.

Preferred refinements, developments and variants are the subject matter of the dependent claims. The advantages and preferred configurations listed with regard to the method can be transferred analogously to the fibre composite body and vice versa.

In concrete terms, the object related to the method is achieved by a method for producing a fibre composite body, the fibre composite body being in particular at least part of a wheel and specifically a wheel rim for a motor vehicle. The method comprises the following steps:

First of all, a first mould having at least one female mould part and one male mould part is provided. In this case, the female mould part can be understood as a negative mould of at least part of the fibre composite body. The male mould part can be understood in this case as the counterpart formed to complement/correspond to the female mould part, so that a space between the female mould part and the male mould part arranged thereon forms the outer contour of at least part of the fibre composite body to be produced. However, the male mould part can also be formed as a membrane which is either likewise formed to be complementary/corresponding to the female mould part or, alternatively, is formed to be flat, i.e. planar.

Subsequently, a fibrous raw material and a binder are introduced into the female mould part. The binder acts as a fixation of the fibrous raw material to form a spongy, solid structure, the cavities of which are filled during infiltration. The fibrous raw material can be, for example, fibre chips made from organic, inorganic or natural fibrous material, preferably carbon, aramid or hemp, wood and sisal fibres. The term “fibre chips” means semi-finished fibre products or fibres cut into small pieces. The binder can be a duroplastic (epoxy) or a thermoplastic (hotmelt) binder powder or a mixture of both. In other words, the binder is preferably a powdered adhesive that can be activated thermally, inductively, or by UV light. Furthermore, the use of a pre-bound (pre-impregnated with binder) semi-finished fibre product made from the fibre types mentioned above is possible. By overfilling or underfilling the first mould, different fibre volume fractions can be set in the range of 30%-70%. Ideally, a fibre volume fraction of 50% is set.

For a better understanding, the following explanations refer to long fibre chips and thermally activatable binder systems.

The mould is then closed by arranging the male mould part on the female mould part in the manner of a lid. An energy input into the mould takes place subsequently, by means of which the binder is activated. Preferably, the energy input takes place by means of an application of pressure and/or temperature on the mould, so that a mould element which is open to diffusion is formed as a result. Open to diffusion can be understood in this case to mean that it is formed to be permeable, i.e. open-pored, and has sufficient strength to carry the preform structure, for example. This method step is also referred to as preforming. As a result, the mould element has a composite structure close to the final contour. It is also possible to use so-called already prefabricated preform or wet-preg shells which are placed in the mould and then backfilled with the fibrous raw material. Almost any physical structure can be produced as a fibre composite body.

The temperature which is applied to the mould preferably has a value in the range from 70° C. to 180° C. The pressure which is applied to the mould to form the mould element preferably has a value between 0.1 MPa and 10 MPa and in particular between 2 MPa and 8 MPa.

The mould element can preferably be a spoked rim or a hub ring. The latter is arranged concentrically around a hub of a wheel rim, for example, in order to act in this case as an insert part in a force-supporting manner in the sense of load introduction and to increase the mechanical stability in this region.

In the next step, the formed mould element which is open to diffusion is joined together with a preform structure. The preform structure can be parts of a wheel for a motor vehicle. The preform structure is for example the rim base having spoke parts when the mould element which is open to diffusion is formed as a spoked rim. In other words, the rest of the wheel rim. Alternatively, the preform structure can also form additional spoke parts and/or additional rim parts.

In the context of the present invention, joining together the mould element and a preform structure is understood to mean, for example, arranging the mould element on a preform structure, in particular a form-fitting connection, by mutual interlocking of correspondingly arranged positive and negative geometric structures on at least one of the contact regions arranged relative to one another, and/or a material-locking connection by means of an activated binder between the contact regions arranged resting against one another, the activation taking place, for example, by means of a further energy input.

For example, in order to join the mould element together with the preform structure, the preform structure is first aligned in an end position. The end position can be understood in this case to mean that the two parts (mould element and preform structure) are aligned and joined together in the way in which they are to form the fibre composite body in a later state. Auxiliary moulds or devices can be used for this purpose. The mould element and preform structure are then transferred to a second mould that forms a cavity. The auxiliary mould then used, also referred to as the second mould, is usually different from the first mould.

A resin is then supplied which preferably infiltrates the entire mould element which is open to diffusion and at least partially the preform structure. In this context, infiltration can be understood to mean that the resin penetrates through the open-pored design of the mould element into intermediate spaces in the structure of the mould element and flows around them.

The resin is then cured. This preferably takes place by means of a second, renewed energy input in the form of an application of pressure and/or an application of temperature, so that the fibre composite body is thereby formed without a boundary layer. Alternatively, depending on the materials used, cold curing is also possible without a second application of temperature. The entire mould element is preferably connected to the preform structure in a form-fitting and material-locking manner by means of the infiltration. Thus, analogously to the example already mentioned above, the complete wheel rim is formed as a fibre composite body.

Then, after the second mould has been opened, the fibre composite body is removed therefrom.

In contrast to the prior art mentioned at the outset, by means of the method described above and in particular the step of at least partially infiltrating the mould element which is open to diffusion with the preform structure, micro-interlocking between the mould element and the preform structure is achieved. As a result of the joint infiltration and curing of the mould element and preform structure (also referred to as co-curing), the fibre composite body has no (chemical) boundary layer. This advantageously results in an increase in the mechanical properties of the fibre composite body. Furthermore, this method is inexpensive and allows what is known as net shape production. Net shape production is understood to mean that the fibre composite body produced no longer needs to be post-processed mechanically or in any other way after it has been removed from the mould, which in turn has advantages with regard to processing standards and production costs.

Sufficient mechanical stability is thus achieved, especially in the case of the fibre composite body in the form of a wheel, in particular in the regions already mentioned at the outset, with a clearly pronounced weight saving compared to other materials. The increased mechanical stability is due in particular to the mould element, also referred to as an insert part, which is already arranged at the required location within the production process using the method described above and, in particular, becomes part of the fibre composite body due to the form-fitting and material-locking connection.

The production of the insert part, the positioning of the insert part in the fibre composite body and the production of the fibre composite body are therefore not three consecutive methods, but are combined in one method.

A filling material is preferably added to the fibrous raw material. The filling material can be understood in this case to be, for example, foam granules, hollow glass balls and/or a closed-cell hollow structure. As a result, a further weight reduction is achieved without significantly sacrificing mechanical stability.

In one embodiment, a polyimide material is alternatively or additionally mixed with the fibrous raw material. This material results in an expansion during the preforming process, i.e. during the first application of pressure and temperature on the mould. As a result, an increase in the density of the mould element is achieved, which in turn contributes to an increase in mechanical stability.

As an alternative to this, “compressing” of the fibrous raw material mixed with the polyimide material takes place by filling the at least one mould beyond a maximum filling quantity and mechanically compressing it when the at least one mould is closed.

According to one embodiment, one or more textile layers are integrated into the mould element which is open to diffusion. The textile layers can be tabs, for example, which are used for later connection of the mould element to the preform structure. The integration of the one or more textile layers preferably takes place as part of the formation of the mould element, i.e. for example before the first application of pressure and temperature, so that the one or more textile layers become part of the mould element.

Alternatively or additionally, one or more textile layers are integrated when joining together the mould element and the preform structure. The integration of the one or more textile layers is based on the idea that, as a result, this allows a later connection of the mould element, formed for example as a spoked rim, to a preform structure formed as a rim base, for example.

According to a preferred embodiment, one or more functional elements are arranged in the mould element and/or the preform structure in order to allow attachment to a wheel suspension, especially when the fibre composite body is formed as a wheel rim. The functional element can be understood in this case to be, for example, a sleeve element for a wheel hub mount or a plurality of sleeves that form the passages for wheel nuts or stud bolts of the wheel suspension.

According to a further embodiment, formations in the sense of pockets and/or depressions and/or special connection geometries can also be formed, which formations can be used for the integration of load elements such as strips, endless fibres or shear-resistant inserts (e.g.: ±45° inserts). In a particular embodiment, these couple with load elements, the insert part, and the preform structure.

In order to optimise the processing and the production of the fibre composite body, according to a preferred embodiment, the application of pressure takes place in multiple stages. In particular when integrating one or more textile layers, as already mentioned above, a multi-stage application of pressure has proven to be advantageous.

Preferably, the application of pressure on the mould takes place by vacuum pressing or over-pressure pressing. Alternatively or additionally, the application of pressure can also take place by a mechanical closing force of the mould, for example by a screw connection. Methods of this type with regard to the application of pressure to the mould are sufficiently well known and thus simplify the method for producing the fibre composite body.

A thermosetting resin or a thermoplastic resin is expediently used as the resin. Alternatively, a mixture of a thermosetting resin of this type and a thermoplastic resin is used.

According to one embodiment, the mould element is connected in particular in a form-fitting manner to a structural segment. The structural segment can, for example, be spoke connections directed radially outwards, as a result of which the mechanical stability of the spokes is increased.

With regard to the fibre composite body, the object is specifically achieved by a fibre composite body, in particular a part of a wheel and especially a part of a car wheel rim made of a fibre composite material. In this case, the fibre composite body has a mould element and a preform structure. The mould element and the preform structure are connected to one another at least in regions in a form-fitting and material-locking manner.

The mould element expediently has a connection to a structural segment, which connection is in particular formed in a form-fitting manner. The structural segment can be a structural foam segment, for example, which is arranged such that it is oriented radially outwards in the manner of spoke connections of the wheel. In this context, radially outwards can be understood to mean a direction from the wheel hub to the rim base. This has the advantage that the mould element and the at least one structural segment do not have to be laboriously joined together, and a simple construction of the fibre composite body with sufficient mechanical stability is thus achieved.

Expediently, the mould element is completely integrated into the preform structure, in particular connected in a completely material-locking and form-fitting manner to the preform structure. A further increase in mechanical stability and a local arrangement of the mould element formed as an insert part are ensured as a result.

According to one embodiment, the fibre composite body has a plurality of mould elements. For example, the fibre composite body formed as a wheel rim can have a mould element formed as a wheel centre in the region of the wheel hub and one or more insert parts in the region of a tyre seat, i.e. in the rim base.

Embodiments of the invention are explained in more detail below with reference to the drawings. In the drawings, partially in a highly simplified representation:

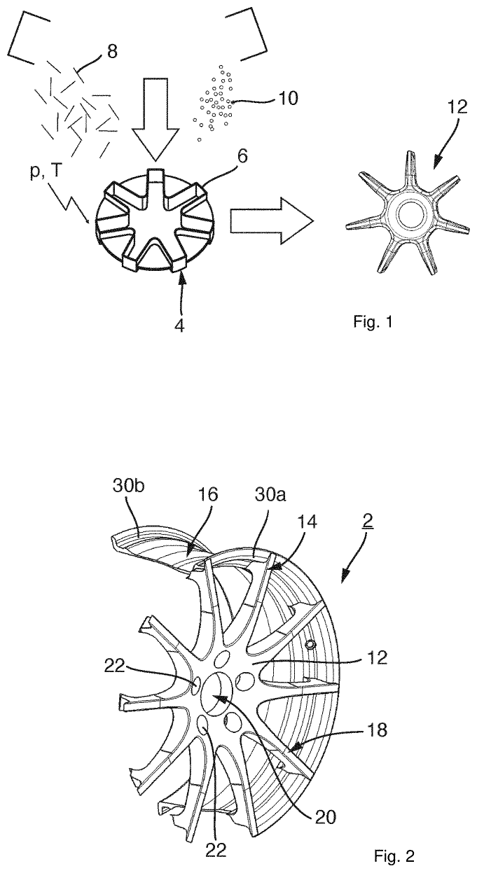

FIG. 1 is a schematic diagram of the method according to the invention for forming a mould element which is open to diffusion;

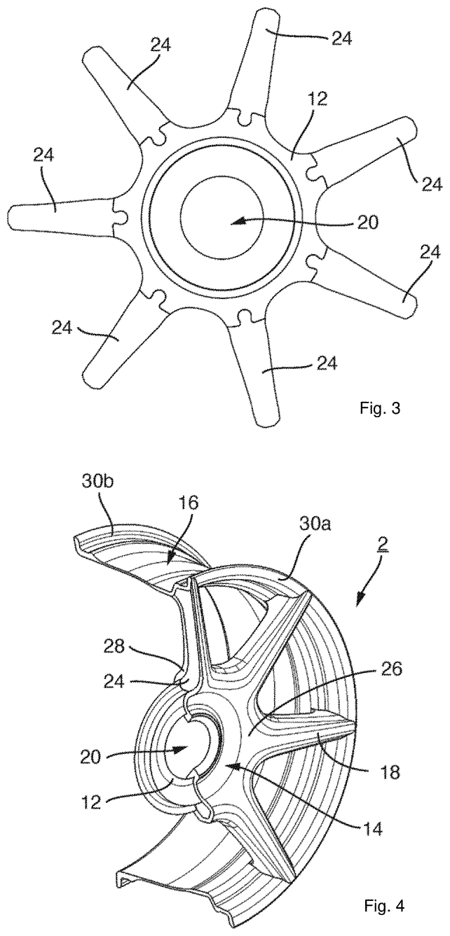

FIG. 2 is a perspective view of a part of a fibre composite body formed as a wheel rim having a preform structure and a mould element;

FIG. 3 is a sketch of a mould element having structural segments arranged thereon in a form-fitting manner;

FIG. 4 is a perspective representation of a fibre composite body formed as a wheel rim having a mould element arranged therein, in accordance with FIG. 3;

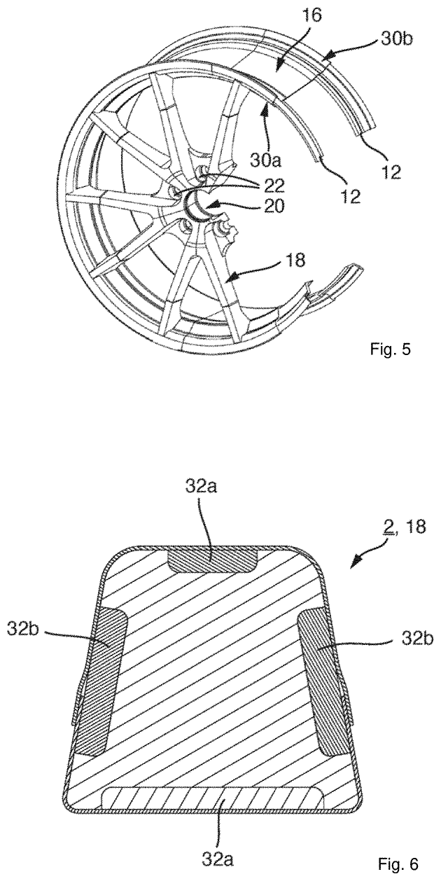

FIG. 5 is a perspective representation of a fibre composite body formed as a wheel rim having two mould elements arranged in the rim base edge;

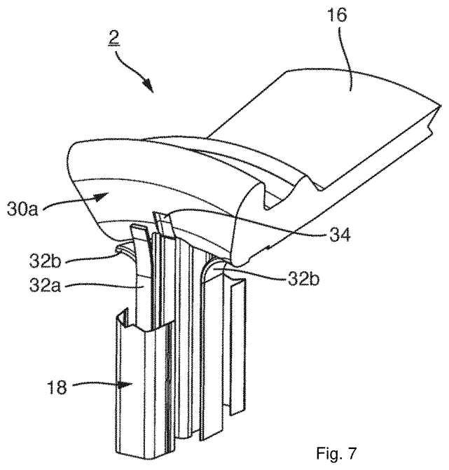

FIG. 6 is a cross section of a fibre composite body with connection geometries formed therein; and

FIG. 7 is an exploded representation of the fibre composite body shown in FIG. 6.

In the drawings, parts that function in the same way are always shown with the same reference signs.

In the method shown schematically in FIG. 1 for producing a fibre composite body 2 (cf. FIG. 2), a mould 4 having a female mould part 6 and a female mould part (not shown here) is provided. In this case, the male mould part is formed to correspond to or complement the female mould part 6.

First, a fibrous raw material 8, such as carbon, glass or natural fibres, and a binder 10 are introduced into the mould 4, specifically into the female mould part 6. The binder 10 is, for example, a duroplastic or thermoplastic binder powder, or a mixture of both. After closing the mould 4, the binder 10 is activated. This takes place by means of an energy input in the form of an application of pressure p and an application of temperature T on the mould 4. The application of pressure p can be understood in this case to mean that the mould 4 and in particular the female mould part 6 and the male mould part are pressed together with a pressure in the range between 0.1 MPa and 10 MPa. In this context, the application of temperature T can be understood to mean that the mould 4 is heated to a temperature having a value between 70° C. and 180° C.

A mould element 12 which is open to diffusion is formed as a result, which mould element is then joined together with the preform structure 14 (not shown in FIG. 1). After supplying a resin which infiltrates, i.e. flows around, both the mould element which is open to diffusion and the preform structure, a second application of pressure p and an optional second application of temperature T take place. As a result, the resin is cured, so that the mould element 12 and the preform structure 14 form a fibre composite body 2.

A fibre composite body 2 of this type is shown, for example, in FIG. 2 in a perspective view. FIG. 2 shows part of a fibre composite body 2 formed as a wheel rim, which fibre composite body has a preform structure 14 and a mould element 12. The mould element 12 is formed as a spoked rim, while the preform structure 14 is formed as a rim base having spokes 18 arranged thereon.

The mould element 12 is thus formed according to FIG. 2 as a spoked rim-shaped insert part and fully meets the mechanical requirements of the structure, especially in the region of the wheel hub mount 20 and the wheel nut bushings 22. Forces usually occur in the region of the wheel hub mount 20 and the wheel nut bushings 22 for which an arrangement of a mould element 12 formed as an insert part has proven to be suitable.

In this case, the forces are transmitted between the wheel hub mount 20 and the rim base 16. Alternatively, in the embodiment according to FIG. 2, the mould element 12 formed as a spoked rim can also be enclosed by further (fabric) layers.

Also, as an alternative or in addition, further functional elements (not shown) can be arranged and in particular integrated in(to) the mould element and, for example, can form the wheel hub mount 20 and/or the wheel nut bushings 22. In this case, sleeves are usually used, which are inserted into the mould element 12.

FIG. 3 shows a sketch of a mould element 12 having structural segments 24 arranged thereon in a form-fitting manner. The arrangement of the structural segments 24 on the mould element 12 takes place in the embodiment according to FIG. 3 in the manner of a tongue-and-groove connection and thus in a form-fitting manner. However, the form fit can also be achieved by means of the infiltration of the resin into the mould element 12 which is open to diffusion, so that micro-interlocking takes place between the mould element 12 and the structural segments 24. In the embodiment, the structural segments 24 are arranged on the mould element 12 oriented radially outwards, so that the mould element 12 having the structural segments 24 arranged thereon forms at least part of a spoked rim.

The structural segments 24 can thus also be referred to as spoke connections. The form-fitting arrangement of the structural segments 24 means that, on the one hand, a simple arrangement on the mould element 12 is achieved and at the same time a sufficiently high degree of dimensional stability is ensured.

FIG. 4 is a perspective representation of a fibre composite body 2, also formed as a wheel rim. The mould element 12 having the structural segments 24 arranged thereon is arranged inside the fibre composite body 2. The mould element 12 having structural segments 24 arranged thereon is substantially the mould element 12 already shown in FIG. 3. It is easy to see here that the structural segments 24 form part of the spokes 18 and the increased dimensional stability achieved by the mould element 12 is therefore not just limited to the wheel hub mount 20 but extends into the spokes 18.

Both the mould element 12 formed as an insert part and the structural segments 24 are completely surrounded by the preform structure 14 and, in particular, are connected thereto without a boundary layer, so that complete micro-interlocking of the preform structure 14 with the mould element 12 and the structural segments 26 results by means of the infiltration. The preform structure 14 is divided into an outer cover layer 26 and an inner cover layer 28. The two cover layers 26, 28 are made of carbon and/or aramid fibres, for example.

The mould element 12 arranged here in the region of the wheel hub mount 20 is formed rotationally symmetrical in the embodiment according to FIG. 4. Alternatively, the mould element 12 can also be non-rotationally symmetrical.

FIG. 5 is a perspective representation of a fibre composite body 2 formed as a wheel rim having two mould elements 12 arranged in the rim base edge 30. Here, in each case a mould element 12 is arranged in an outer rim base edge 30a and an inner rim base edge 30b. The inner rim base edge 30b can be understood to mean the rim base edge 30 that is oriented in the direction of the wheel suspension (not shown), while the outer rim base edge 30a can be understood to mean the rim base edge 30 that is oriented away from the wheel suspension.

The two mould elements 12 are also completely enclosed by the preform structure 14 and are connected thereto in a form-fitting and material-locking manner. The two mould elements 12 also serve in this case as insert parts for mechanical stabilisation and thus increase the mechanical resilience of the rim base.

The embodiment according to FIG. 5 having the mould element 12 arranged within the rim base edge 30 can also be used in a so-called hybrid wheel. A hybrid wheel can be understood to mean a wheel rim that is made from at least two different materials. For example, a hybrid wheel can have a metal wheel centre and a rim base made of a fibre composite material.

Furthermore, variable wall thicknesses in the region of the wheel hub on the rim base edge 30 are made possible by the mould elements 12 formed as insert parts.

A cross section of a fibre composite body 2 is shown in FIG. 6. Specifically, FIG. 6 shows a cross section through a spoke 18. Connection geometries are formed as pockets in the fibre composite body 2. Load elements 32a for tension-compression stresses and load elements 32b for shear stresses are inserted into these pockets.

FIG. 7 shows part of the spoke 18 shown in FIG. 6 and its connection to a rim base 16 as an exploded representation. In this case, the load elements 32a, 32b are introduced into the rim base 16. In order to achieve a fitting arrangement of the load elements 32a, 32b in the rim base 16, said rim base has recesses 34 in the embodiment according to FIG. 7, in which recesses an upper part or upper end of the respective load elements 32a, 32b is arranged. In the embodiment according to FIG. 7, the spoke 18 is formed to be substantially rectangular. At least one load element 32a for tension-compression stresses and/or one load element 32b for shear stresses is expediently arranged on each side of the spoke 18. Alternatively, a plurality of load elements 32a, 32b can also be arranged on one side of the spoke 18 in each case.

Preferably, the upper parts of the load elements 32a, 32b lie flush in the recesses 34, so that a planar and level outer rim base edge 30a of the rim base 16 is formed. The load elements 32a, 32b arranged in this way in the rim base 16 serve to increase the mechanical resistance of the spoke 18 against tensile and compression stresses. All the spokes 18 of a fibre composite body 2 formed as a vehicle wheel preferably have load elements 32a, 32b of this type.

The free upper part or end of the respective load elements 32a, 32b is inclined or curved outwards. The corresponding recess 34 is adapted so that the load element 32a, 32b, in particular the free upper end of the corresponding load element 32a, 32b, is received flat in the recess 34.

The invention is not limited to the embodiments described above. On the contrary, other variants of the invention can also be derived from this by a person skilled in the art without departing from the subject matter of the invention. In particular, all of the individual features described in connection with the embodiments can also be combined with one another in other ways without departing from the subject matter of the invention.

### LIST OF REFERENCE SIGNS

2 Fibre composite body

4 Mould

6 Female mould part

8 Fibrous raw material

10 Binder

12 Mould element

14 Preform structure

16 Rim base

18 Spoke

20 Wheel hub mount

22 Wheel nut mount

24 Structural segment

26 Outer cover layer

28 Inner cover layer

30a Outer rim base edge

30b Inner rim base edge

32a Load element for tension-compression stress

32b Load element for shear stress

34 Recesses in the rim base

p Application of pressure

T Application of temperature

1. A method for producing a fibre composite body (2), in particular at least a part of a wheel, comprising the following steps:
providing a first mould (4) having at least one female mould part (6) and one male mould part;
introducing a fibrous raw material (8) and a binder (10) into the female mould part (6);
activating the binder (10) by an energy input (p, T) into the mould (4) to form a mould element (12) which is open to diffusion;
joining together the mould element (12) and a preform structure (14);
supplying a resin, so that the resin infiltrates at least partially into the mould element (12) which is open to diffusion and into the preform structure (14); and
curing the resin, so that, as a result, the fibre composite body (2) is formed without a boundary layer.

2. The method according to claim 1, wherein
the binder is added to the fibrous raw material (8).

3. The method according to claim 2, wherein
the binder is thermoplastic, thermoseting or a mixture of both.

4. The method according to claim 1, wherein
a polyimide material is added to the fibrous raw material (8).

5. The method according to claim 1, wherein
one or more textile layers are integrated into the mould element (12) which is open to diffusion.

6. The method according to claim 1, wherein
one or more textile layers are integrated when joining together the mould element (12) which is open to diffusion and the preform structure (14).

7. The method according to claim 1, wherein
one or more functional elements are arranged, in particular integrated, in(to) the mould element (12) which is open to diffusion and/or in(to) the preform structure (14).

8. The method according to claim 1, wherein
the mould element (12) has one or more formations for the integration of coupling load elements.

9. The method according to claim 1, wherein
the energy input (p, T) takes place in multiple stages.

10. The method according to claim 1, wherein
the energy input (p, T) comprises vacuum pressing or over-pressure pressing or a closing force of the at least one mould (4).

11. The method according to claim 1, wherein
the at least one female mould part (6) is made of a duroplastic material or of a thermoplastic material or of a mixture of duroplastic and thermoplastic material.

12. The method according to claim 1, wherein
the mould element (12) which is open to diffusion is connected to a structural segment (24), in particular in a form-fitting manner.

13. A fibre composite body (2), in particular a wheel, made of a fibre composite material having
a mould element (12) which is open to diffusion and
a preform structure (14), wherein the mould element (12) which is open to diffusion and the preform structure (14) are connected to one another at least partially without a boundary layer.

14. A fibre composite body (2) according to claim 13, wherein
the mould element (12) which is open to diffusion and the preform structure (14) are connected to one another in a form-fitting manner.

15. A fibre composite body (2) according to claim 13, wherein
the mould element (12) which is open to diffusion is formed as an insert part.

16. The fibre composite body (2) according to claim 13, wherein
the mould element (12) which is open to diffusion has at least one connection to a structural segment (24), which connection is formed in particular in a form-fitting manner.

17. The fibre composite body (2) according to claim 13, wherein
the mould element (12) which is open to diffusion is completely integrated into the preform structure (14), in particular is completely connected to the preform structure (14) without a boundary layer.

18. The fibre composite body (2) according to claim 13, which has a plurality of mould elements (12) which are open to diffusion.

19. The method according to claim 3, wherein:
a polyimide material is added to the fibrous raw material (8); and
one or more textile layers are integrated into the mould element (12) which is open to diffusion.

20. The method according to claim 19, wherein:
the energy input (p, T) takes place in multiple stages; and
the energy input (p, T) comprises vacuum pressing or over-pressure pressing or a closing force of the at least one mould (4).
